(19) United States
(12) Patent Application Publication
(10) Pub. No.: US 2014/0108508 A1
(43) Pub. Date: Apr. 17, 2014

(54) Cloud subscription download method and system, and computer storage medium

(71) Applicant: TENCENT TECHNOLOGY (SHENZHEN) COMPANY LIMITED, Shenzhen (CN)

(72) Inventors: Gang Liu, Shenzhen (CN); Chenyuan Zhu, Shenzhen (CN); Zufeng Ji, Shenzhen (CN); Yan Huang, Shenzhen (CN)

(21) Appl. No.: 14/098,984

(22) Filed: Dec. 6, 2013

Related U.S. Application Data
(63) Continuation of application No. PCT/CN2012/087448, filed on Dec. 25, 2012.

(30) Foreign Application Priority Data
Feb. 13, 2012 (CN) 2012100315290

(51) Int. Cl. H04L 29/08

(52) U.S. Cl. CPC H04L 67/104
USPC 709/203

(57) ABSTRACT

A cloud subscription download method is described, which includes the following steps: a download client sends a download request to a cloud subscription server group; the cloud subscription server group queries whether a file corresponding to the download request is downloaded by the cloud subscription server group, and when the file is not downloaded, the cloud subscription server group downloads and stores the file; after the download is completed, the cloud subscription server group notifies the download client of an entry address for storing the file; and the download client downloads the file from the cloud subscription server group according to the entry address. A cloud subscription download system is further described. The method achieves high-speed download to save time, and provides stable download resources to ensure a stable download speed.

### CROSS REFERENCE TO RELATED APPLICATIONS

This is a continuation application of International Patent Application No.: PCT/CN2012/087448, filed on Dec. 25, 2012, which claims priority to Chinese Patent Application No. 201210031529.0 filed by TENCENT TECHNOLOGY (SHENZHEN) COMPANY LIMITED on Feb. 13, 2012, entitled “CLOUD SUBSCRIPTION DOWNLOAD METHOD AND SYSTEM”, the disclosure of which is incorporated by reference herein in its entirety.

### TECHNICAL FIELD

The disclosure relates to Internet download technology, and in particular to a cloud subscription download method, a cloud subscription download system and a computer storage medium.

### BACKGROUND

Peer-to-Peer (P2P) technology, as a new network technology, relies on computing capability and bandwidth of participants in a network, rather than merely on several servers. The P2P technology has been widely used in file sharing and downloading. A download speed of one peer of P2P is closely related to an upload speed of the other peer. Users mostly surf the Internet with an Asymmetric Digital Subscriber Line (ADSL), an upload speed of which is not fast and is merely several tens KB/s, and some of the users may also limit the upload speed artificially, thereby resulting in lack of upload bandwidth resources in P2P manner. Therefore, the users generally feel the download speed of P2P is slow.

With Peer to Server (P2S) technology, a user can download files from a certain large downloading website directly. Since files are stored in a website server, the download speed can be ensured, but resources are dispersed and thus are not easy to be searched for.

For Peer to Server & Peer (P2SP) technology, the peer is a network node or a terminal (for example, a user computer). Unlike conventional modes that downloading can only rely on a server, transmission of contents can be implemented in various terminal machines in a network by using the P2SP technology. Different from P2P and P2S, P2SP is based on user to server & user mechanism. The P2SP not only supports the P2P technology, but also integrates server resources with P2P resources by searching a database. When a user downloads a file, other P2P resources will be searched automatically and appropriate resources are selected to accelerate. This enables the P2SP technology to effectively integrate the server and mirror resources thereof with isolated P2P resources, therefore the P2SP technology has a great improvement in downloading stability and download speed compared with the conventional P2P or P2S technology. Current mainstream download software such as Thunder and Whirlwind both use the P2SP technology.

In the P2SP technology, to download a file, data sources includes an original link, a P2P network and a third-party mirrored auxiliary source, and the file is connected in series uniformly by a unique identifier of the complete file, such as MD5 or SHA. An existing P2SP downloading flow is shown in FIG. 1 and FIG. 2, which specifically includes the following steps:

At step 101, when a download client needs to download a file, the download client acquires a Universal Resource Locator (URL) link of the file from the Internet or a resource website.

At step 102, the download client takes the URL link as an entry, queries multiple URL resources and a file Hash value from a resource index server, queries P2P seeds through a Tracker server, downloads the file from the Internet according to the acquired multiple URL resource set and the acquired file Hash value, and downloads the file from download clients corresponding to the acquired P2P seeds.

The corresponding download clients are generally Peers that complete a download and Peers that are performing a download.

At step 103, after the download client completes the download, the download client registers file information to the Tracker server, so that other download clients can query the P2P seeds through the Tracker service.

At step 104, after the download client completes the download, the download client reports related statistical information to a statistics server.

By taking a URL link as an entry, the download client can acquire a batch of URLs with the help of a backend server. Those URLs provide entries of multiple data sources to the download client, thereby improving the downloading performance and the download speed of the download client. Here, the download speed of the download client relies on downloading quality of sources.

Although the download speed can be increased by using the existing multi-source download technology, when speeds of sources and a P2P are both unsatisfactory, a user often needs to hang up for a long time to download some movies or game resources, which not only wastes time but also consumes a lot of bandwidth. For example, a normal maximum download speed of the user can reach 200 KB/S, but for a certain resource that is unpopular, the download speed of which can merely reach 10 KB/S, so that the user needs to download for a long time.

In recent years, due to the blockade of Internet Service Providers (ISPs) to P2P download, a user cannot download Internet resources even though the user pays. Furthermore, since content supervision is becoming increasingly rigorous and a lot of personal video websites shut down, video resources will become scarce resources that cannot be acquired without paying. Meanwhile, free video resources may be transferred to foreign servers, and therefore the speed of downloading movies for free users will be decreased sharply. Existing downloading modes cannot solve the problem of unstable download resources.

### SUMMARY

In view of this, the disclosure provides a cloud subscription download method, a cloud subscription download system and a computer storage medium, which are capable of achieving high-speed download to save time and providing stable download resources to ensure a stable download speed.

An embodiment of the disclosure provides a cloud subscription download method, which includes the following steps:

a download client sends a download request to a cloud subscription server group;

the cloud subscription server group queries whether a file corresponding to the download request is downloaded by the cloud subscription server group, and when the file is not downloaded, the cloud subscription server group downloads and stores the file;

after the download is completed, the cloud subscription server group notifies the download client of an entry address for storing the file; and the download client downloads the file from the cloud subscription server group according to the entry address.

An embodiment of the disclosure provides a cloud subscription download system, which includes a download client and a cloud subscription server group;

the download client is configured to: send a download request to the cloud subscription server group; and download a file from the cloud subscription server group according to an entry address provided by the cloud subscription server group; and the cloud subscription server group is configured to: query whether a file corresponding to the download request is downloaded by the cloud subscription server group, and when the file is not downloaded, download and store the file; and after the download is completed, notify the download client of an entry address for storing the file.

An embodiment of the disclosure provides a computer storage medium storing a computer program that, when executed, implements the aforementioned cloud subscription download method.

According to the cloud subscription download method, system and computer storage medium of the disclosure, a download client sends a download request to a cloud subscription server group; the cloud subscription server group queries whether a file corresponding to the download request is downloaded by the cloud subscription server group, and when the file is not downloaded, the cloud subscription server group downloads and stores the file; after the download is completed, the cloud subscription server group notifies the download client of an entry address for storing the file; and the download client downloads the file from the cloud subscription server group according to the entry address. In this way, high-speed download is achieved to save time, and stable download resources can be provided to ensure a stable download speed.

### BRIEF DESCRIPTION OF THE DRAWINGS

FIG. 1 is a schematic diagram of a structure of a system for downloading a file using P2SP technology in the related art;

FIG. 2 is a schematic flowchart of a method for downloading a file using P2SP technology in the related art;

FIG. 3 is a schematic flowchart of a cloud subscription download method according to an embodiment of the disclosure; and

FIG. 4 is a schematic diagram of a structure of a cloud subscription download system according to an embodiment of the disclosure.

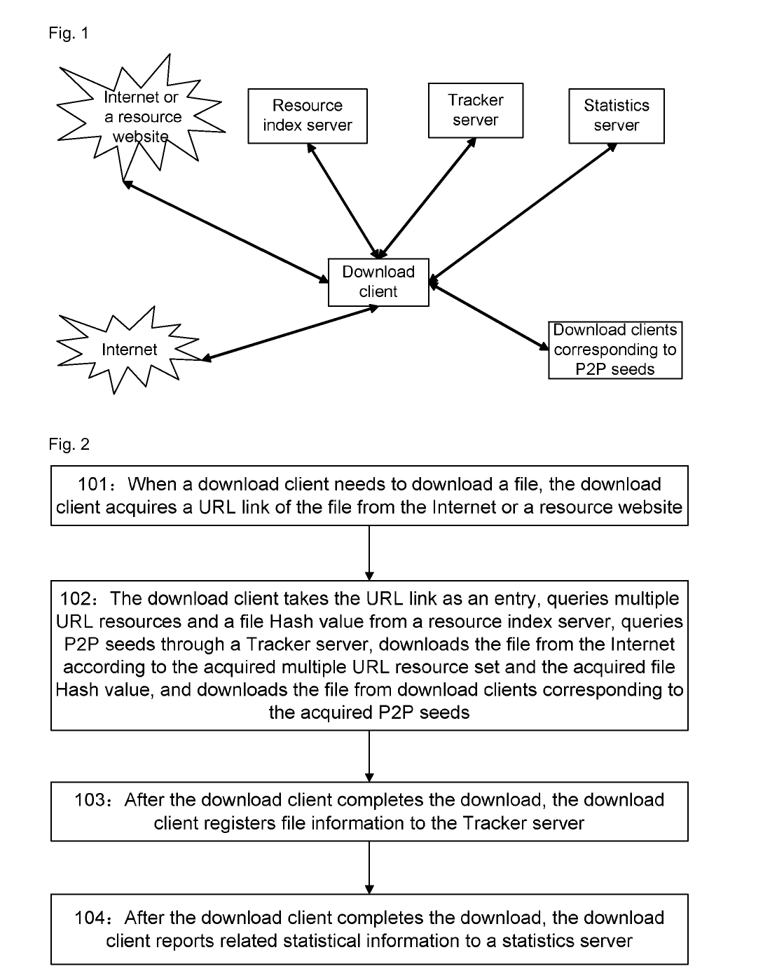

### DETAILED DESCRIPTION

The basic idea of the disclosure is: a download client sends a download request to a cloud subscription server group; the cloud subscription server group queries whether a file corresponding to the download request is downloaded by the cloud subscription server group, and when the file is not downloaded, the cloud subscription server group downloads and stores the file; after the download is completed, the cloud subscription server group notifies the download client of an entry address for storing the file; and the download client downloads the file from the cloud subscription server group according to the entry address.

The disclosure is further elaborated below in conjunction with the drawings and embodiments.

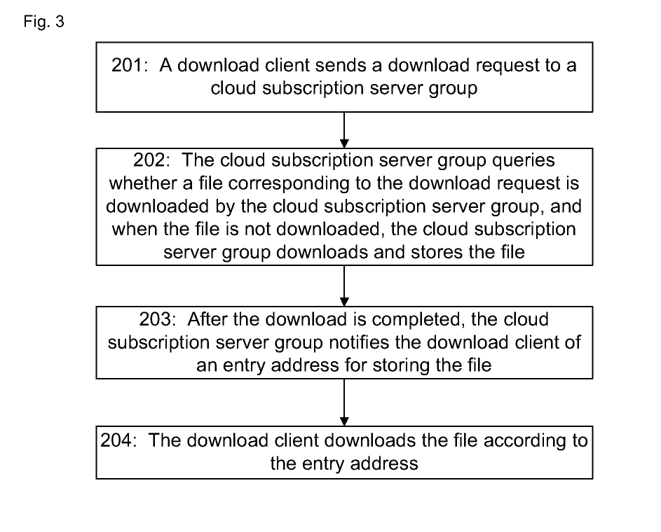

An embodiment of the disclosure provides a cloud subscription download method. As shown in FIG. 3, the method includes the following steps:

At step 201, a download client sends a download request to a cloud subscription server group.

Specifically, the download client sends the download request to the cloud subscription server group via the Internet.

The download request includes a file download address, such as a Hyper Text

Transport Protocol (HTTP) link for downloading a file, or an eMule link for downloading a file, or a Bit Torrent (BT) download seed for downloading a file, or a Magnet link for downloading a file.

The cloud subscription server group includes a download task management server, a download task distribution server, a download server farm, a cloud storage server, and so on.

At step 202, the cloud subscription server group queries whether a file corresponding to the download request is downloaded by the cloud subscription server group, and when the file is not downloaded, the cloud subscription server group downloads and stores the file.

Specifically, the download task management server in the cloud subscription server group writes the file download address in the download request into a database, and queries a database mapping record according to the file download address to determine whether the file is downloaded. The database records a hash characteristic value and a corresponding status (such as the download being completed or the download being doing) of the file downloaded by the cloud subscription server group. When the file is not downloaded, the download task management server sends a download task request including a file download address to the download task distribution server. The download task distribution server schedules tasks according to a load condition of the download server farm. The download server farm downloads the file according to the file download address, synchronizes the downloaded file to the cloud storage server that stores the downloaded file, and writes a download result into the database. The file corresponding to the download request being downloaded includes that the file is being downloaded and the file is downloaded completely.

Preferably, the cloud storage server sets a valid period for the stored file, and deletes the stored file when the set valid period expires.

Preferably, the download server farm downloads the file according to the file download address by using the P2SP download technology, that is, the download server farm takes the file download address as an entry, queries multiple URL resources and a file Hash value from a resource index server, queries P2P seeds through Tracker service, downloads the file from the Internet according to the multiple URL resource set and the file Hash value acquired, and downloads the file from download clients corresponding to the P2P seeds acquired.

Preferably, the download server farm reports download progress and intermediate state information to the download task distribution server during downloading the file, and the download task distribution server reports the download process and the intermediate state information to the download task management server.

Preferably, at the step 202, the download client logs in to the download task management server to query download progress information.

Preferably, at the step 202, when it is determined through querying according to the file download request that the file corresponding to the file download request is downloaded by the cloud subscription server group, the cloud subscription server group directly notifies the download client of the entry address for storing the file; and then step 204 is executed.

At step 203, after the download is completed, the cloud subscription server group notifies the download client of an entry address for storing the file.

Specifically, after the download is completed, the download task management server in the cloud subscription server group asynchronously notifies, through a notification such as a mail and a short message, the download client of a result of performing a download task; the notification includes an entry address for downloading the file by the download client from the cloud storage server, which is a download source of the download client.

At step 204, the download client downloads the file according to the entry address.

Specifically, the download client downloads the file according to the entry address by using the P2SP download technology.

Preferably, at the step 204, after the download client completes the download, the download client reports related statistical information to a statistics server for subsequent statistical analysis in the form of log; the related statistical information includes: a download speed, downloading time, a connection condition, a download result, a file size and other information when the downloading is completed and during downloading a file.

The aforementioned method further includes the following steps: a Web client sends a download request including a file download task to an HTTP protocol conversion server; when the file download task is a task of an HTTP protocol, a task of an eMule protocol or a task of a Magnet protocol, the HTTP protocol conversion server converts a format of the download request into an HTTP protocol format, and sends the converted download request to the cloud subscription server group, and the cloud subscription server group downloads the file; when the file download task is a task of a BT protocol, the HTTP protocol conversion server parses BT seed files through a BT seed parsing server and a BT seed database, and displays the parsed BT seed files to the Web client; the Web client selects a BT seed file to be downloaded, the HTTP protocol conversion server sends the BT seed file selected by the Web client to the cloud subscription server group, and the cloud subscription server group downloads the file.

The step that the HTTP protocol conversion server parses BT seed files through a BT seed parsing server and a BT seed database and displays the BT seed files to the Web client includes the following steps: the HTTP protocol conversion server sends the task of the BT protocol to the BT seed parsing server; the BT seed parsing server extracts BT seed files from the BT seed database according to the task of the BT protocol, and parses the BT seed files; and the HTTP protocol conversion server displays the parsed BT seed files to the Web client.

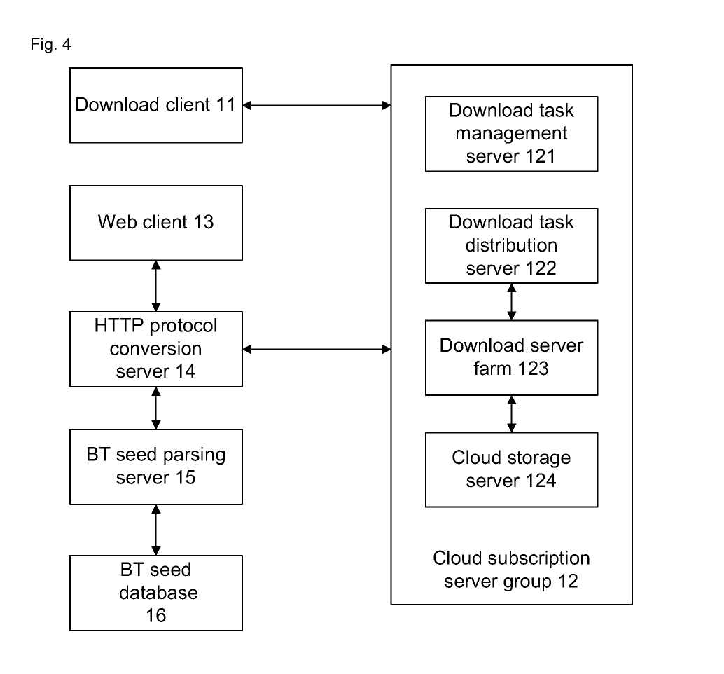

In order to implement the aforementioned method, an embodiment of the disclosure further provides a cloud subscription download system. As shown in FIG. 4, the cloud subscription download system includes a download client 11 and a cloud subscription server group 12.

The download client 11 is configured to: send a download request to the cloud subscription server group 12; and download a file from the cloud subscription server group 12 according to an entry address provided by the cloud subscription server group 12.

The cloud subscription server group 12 is configured to: query whether a file corresponding to the download request is downloaded by the cloud subscription server group 12, and when the file is not downloaded, download and store the file; and after the download is completed, notify the download client 11 of an entry address for storing the file.

The cloud subscription server group 12 includes a download task management server 121, a download task distribution server 122, a download server farm 123 and a cloud storage server 124.

The download task management server 121 is configured to: write a file download address in the download request into a database; query a database mapping record according to the file download address to determine whether a file corresponding to the file download address is downloaded, and when the file is not downloaded, send a download task request to the download task distribution server 122, wherein the download task request includes the file download address; and after a download task is completed, notify, through a notification, the download client 11 of a result of performing the download task, wherein the notification includes an entry address for downloading the file by the download client 11 from the cloud storage server 124.

The download task distribution server 122 is configured to schedule tasks according to a load condition of the download server farm 123.

The download server farm 123 is configured to: download the file according to the file download address, and synchronize the downloaded file to the cloud storage server 124; and write a download result into the database.

The cloud storage server 124 is configured to store the downloaded file, and to provide a downloading source to the download client.

The download server farm 123 is further configured to: report download process and intermediate state information to the download task distribution server 122 during downloading the file;

correspondingly, the download task distribution server 122 is further configured to: receive the download process and the intermediate state information reported by the download server farm 123; and report the download process and the intermediate state information to the download task management server 121; and

the download task management server 121 is further configured to: receive the download process and the intermediate state information reported by the download task distribution server 122.

The cloud storage server 124 is further configured to set a valid period for the stored file and delete the stored file when the set valid period expires.

The download server farm 123 is configured to download the file by using the P2SP download technology, that is, the download server farm 123 takes the file download address as an entry, queries multiple URL resources and a file Hash value from a resource index server, queries P2P seeds through Tracker service, downloads the file from the Internet according to the multiple URL resource set and the file Hash value acquired, and downloads the file from download clients corresponding to the P2P seeds acquired.

The download server farm 123 is further configured to: register an address of the download server farm 123 to the download task distribution server 122, and report disk space and CPU load information to the download task distribution server 122 that performs dynamically equalized task scheduling according to the load; and write the Hash value of a final file downloaded and generated into a database.

The download task management server 121 is further configured to: when it is determined through querying according to the file download request that the file corresponding to the file download request is downloaded by the download server farm 123, directly notify the download client 11 of an entry address for storing the file.

The cloud subscription download system further includes: a Web client 13, an HTTP protocol conversion server 14, a BT seed parsing server 15, and a BT seed database 16.

The Web client 13 is configured to: send a download request including a file download task to an HTTP protocol conversion server 14.

The HTTP protocol conversion server 14 is configured to: when the file download task is a task of the HTTP protocol, a task of the eMule protocol or a task of the Magnet protocol, convert a format of the download request into an HTTP protocol format, and send the converted download request to the cloud subscription server group 12; when the file download task is a task of the BT protocol, send the task of the BT protocol to the BT seed parsing server 15, display the parsed BT seed files to the Web client 13, and send a BT seed file selected by the Web client 13 to the cloud subscription server group 12.

The BT seed parsing server 15 is configured to: extract the BT seed files from the BT seed database 16 according to the task of the BT protocol, parse the BT seed files, and send the parsed BT seed files to the HTTP protocol conversion server 14.

The BT seed database 16 is configured to provide the BT seed files to the BT seed parsing server 15.

The BT seed parsing server 15 is further configured to store BT seeds uploaded by the Web client 13 into the BT seed database 16.

When the download client and the cloud subscription server described in the embodiments of the disclosure are implemented in the form of software function modules and are sold or used as independent products, the download client and the cloud subscription server can also be stored in a computer-readable storage medium. Based on such understanding, as to the technical solutions of the embodiments of the disclosure, the portion that contributes to the prior art can be embodied in the form of a computer software product. The computer software product is stored in a storage medium, which includes a set of instructions causing a computer device (such as a personal computer, a server, or a network equipment) to implement all or a part of the method described in all embodiments of the disclosure. The aforementioned storage medium includes various mediums that can store program codes, such as a U disk, a mobile hard disk, a Read-Only Memory (ROM), a Random Access Memory (RAM), a diskette, or an optical disk. Therefore, the embodiments of the disclosure are not limited to any specific combination of hardware and software.

Correspondingly, an embodiment of the disclosure provides a computer storage medium, storing a computer program that, when executed, implements the cloud subscription download method according to the embodiments of the disclosure.

There are the following advantages in downloading a file using the downloading method according to the embodiments of the disclosure:

(1) High-speed download: Compared with an ADSL network, a file can be downloaded to an exclusive server quicker using the cloud subscription server group with a powerful bandwidth; and after the downloading is completed, the file can be downloaded to the download client at a high speed and stably.

(2) Stable resources: The cloud subscription server group provides stable download resources to the download client, and ensures a stable download speed.

(3) Saving time: On-hook time is saved. The cloud subscription server group provides continuous 7*24-hour high-speed download, thus achieving a greater downloading efficiency of the download client and a higher downloading time utilization rate. Therefore, a user can need no on-hook downloading, thus saving valuable time, then saving a power supply, reducing overall energy consumption, and promoting green environmental protection.

The above are only the preferable embodiments of the disclosure and, are not intended to limit the scope of the disclosure.

1. A cloud subscription download method, comprising:
sending, by a download client, a download request to a cloud subscription server group;
querying, by the cloud subscription server group, whether a file corresponding to the download request is downloaded by the cloud subscription server group, and when the file is not downloaded, downloading, by the cloud subscription server group, the file and storing the file;
after the download is completed, notifying, by the cloud subscription server group, the download client of an entry address for storing the file; and
downloading, by the download client, the file from the cloud subscription server group according to the entry address.

2. The method according to claim 1, wherein the download request comprises a file download address, and the file download address is a Hyper Text Transport Protocol (HTTP) link for downloading a file, or an eMule link for downloading a file, or a Bit Torrent (BT) download seed for downloading a file, or a Magnet link for downloading a file.

3. The method according to claim 2, wherein the cloud subscription server group comprises: a download task management server, a download task distribution server, a download server farm and a cloud storage server.

4. The method according to claim 3, wherein the step of querying, by the cloud subscription server group, according to the download request whether a file corresponding to the download request is downloaded by the cloud subscription server group, and when the file is not downloaded, downloading, by the cloud subscription server group, the file and storing the file comprises:
querying, by the download task management server in the cloud subscription server group, a database mapping record according to the file download address in the download request to determine whether a file corresponding to the file download address is downloaded, and when the file is not downloaded, sending, by the download task management server, a download task request to the download task distribution server;
scheduling, by the download task distribution server, tasks according to a load condition of the download server farm;
downloading, by the download server farm, the file according to the file download address, and synchronizing the downloaded file to the cloud storage server; and
storing, by the cloud storage server, the downloaded file.

5. The method according to claim 4, wherein the step of downloading, by the download server farm, the file according to the file download address comprises: downloading, by the download server farm, the file according to the file download address by using Peer to Server & Peer (P2SP) download technology.

6. The method according to claim 1, further comprising: when the cloud subscription server group determines, according to the download request, that the file corresponding to the file download request is downloaded by the cloud subscription server group, directly notifying, by the cloud subscription server group, the download client of an entry address for storing the file.

7. The method according to claim 1, further comprising:
sending, by a Web client, a download request to an HTTP protocol conversion server, wherein the download request comprises a file download task;
when the file download task is a task of an HTTP protocol, a task of an eMule protocol or a task of a Magnet protocol, converting, by the HTTP protocol conversion server, a format of the download request into an HTTP protocol format, sending, by the HTTP protocol conversion server, the converted download request to the cloud subscription server group, and downloading the file by the cloud subscription server group; and
when the file download task is a task of a BT protocol, parsing, by the HTTP protocol conversion server, BT seed files through a BT seed parsing server and a BT seed database, displaying the BT seed files to the Web client, selecting, by the Web client, a BT seed file to be downloaded, sending, by the HTTP protocol conversion server, the BT seed file selected by the Web client to the cloud subscription server group, and downloading the file by the cloud subscription server group.

8. A cloud subscription download system, comprising: a download client and a cloud subscription server group, wherein
the download client is configured to: send a download request to the cloud subscription server group; and download a file from the cloud subscription server group according to an entry address provided by the cloud subscription server group; and
the cloud subscription server group is configured to: query whether a file corresponding to the download request is downloaded by the cloud subscription server group, and when the file is not downloaded, download and store the file; and after the download is completed, notify the download client of an entry address for storing the file.

9. The system according to claim 8, wherein the cloud subscription server group comprises: a download task management server, a download task distribution server, a download server farm and a cloud storage server, wherein
the download task management server is configured to: write a file download address in the download request into a database; query a database mapping record according to the file download address to determine whether a file corresponding to the file download address is downloaded, and when the file is not downloaded, send a download task request to the download task distribution server, wherein the download task request comprises the file download address; and after a download task is completed, notify, through a notification, the download client of a result of performing the download task, wherein the notification comprises an entry address for downloading the file by the download client from the cloud storage server;
the download task distribution server is configured to schedule tasks according to a load condition of the download server farm;
the download server farm is configured to: download the file according to the file download address, and synchronize the downloaded file to the cloud storage server; and
the cloud storage server is configured to store the downloaded file, and to provide a download source to the download client.

10. The system according to claim 9, wherein the download task management server is further configured to: when it is determined through querying according to the file download request that the file corresponding to the file download request is downloaded by the download server farm, directly notify the download client of an entry address for storing the file.

11. A computer storage medium storing a computer program that, when executed, implements the method according to claim 1.

12. A computer storage medium storing a computer program that, when executed, implements the method according to claim 2.

13. A computer storage medium storing a computer program that, when executed, implements the method according to claim 3.

14. A computer storage medium storing a computer program that, when executed, implements the method according to claim 4.

15. A computer storage medium storing a computer program that, when executed, implements the method according to claim 5.

16. A computer storage medium storing a computer program that, when executed, implements the method according to claim 6.

17. A computer storage medium storing a computer program that, when executed, implements the method according to claim 7.
